(19) United States
(12) Patent Application Publication
(10) Pub. No.: US 2005/0092957 A1
(43) Pub. Date: May 5, 2005

(54) Regulator with over-molded poppet

(76) Inventors: Scott Headings, Richmond Heights, OH (US); David J. Hasak, Concord, OH (US); Eric Kvarda, Mentor, OH (US); Ryan Noble, Chardon, OH (US)

Correspondence Address: CALFEE HALTER & GRISWOLD, LLP, 800 SUPERIOR AVENUE, SUITE 1400, CLEVELAND, OH, 44114, US

(21) Appl. No.: 10/958,150

(22) Filed: Oct. 4, 2004

Related U.S. Application Data
(60) Provisional application No. 60/481,462, filed on Oct. 3, 2003.

(51) Int. Cl. F16K 1/00; F16K 15/00; F16K 31/12; F16K 31/36

(52) U.S. Cl. 251/318

(57) ABSTRACT

A poppet assembly such as can be used with a flow control device such as a valve or pressure regulator. The poppet comprises a metal core and an over-molded elastomeric casing. In one embodiment the casing comprises a perfluoroelastomer.

### RELATED APPLICATIONS

This application claims the benefit of United States provisional patent application Ser. No. 60/481,462 for REGULATOR WITH OVER-MOLDED POPPET filed on Oct. 3, 2003, the entire disclosure of which is fully incorporated herein by reference.

### BACKGROUND OF THE INVENTION

In the process of manufacturing semiconductor devices the flow containment and control devices must maintain an ultra high purity (UHP) quality of the fluid which typically is in the form of a gas. Specific to the flow control device of a pressure regulator the challenge of maintaining the UHP quality of the fluid while performing pressure regulation has been achieved by a design currently sold under U.S. Pat. No. 5,303,734 B1. While this patent is directed to other aspects of pressure regulation it does depict a poppet configuration (68) which is common to other regulators utilized in the semiconductor manufacturing process. Two commonly used polymers are polychlorotrifluoroethylene (PCTFE) or the polyimide trade name Vespel. These are used primarily because of their chemical compatibility with the UHP gases. The poppet is made entirely of the polymer material and therefore harder plastics typically are used.

In non-UHP applications, materials with a lower durometer reading (i.e. a measure of relative hardness) have been utilized, however they are undesirable in UHP applications due to chemical compatibility. As well, being of a lower durometer reading (i.e. softer) the geometry and resulting flow is less stable.

### SUMMARY OF THE INVENTION

The invention contemplates a poppet for a pressure regulator design that has a stable geometry and a relatively lower durometer so as to provide a seal function. In one embodiment, a poppet is provided with an over molded lower durometer material such as an elastomeric material. In accordance with another aspect of the invention, a poppet is contemplated having an over-molded material and a geometry that reduces stress on the over molded material. By providing a stable geometry a stable flow is achieved through the regulator.

These and other aspects and advantages of the present invention will be understood from the following description of the exemplary embodiment in view of the accompanying drawings.

### BRIEF DESCRIPTION OF THE DRAWINGS

FIG. 1 is an enlarged view of a poppet section of a regulator in longitudinal cross-section;

FIG. 2 is an enlarged view of the circled portion of FIG. 1; and

FIG. 3 illustrates another embodiment of the invention.

### DETAILED DESCRIPTION OF THE INVENTION

The invention relates to a poppet assembly such as may be used with a pressure regulator, however, the invention may find use in other poppet-based applications such as valves for example or other flow control devices. While the invention is described with particular reference to an exemplary regulator, such description is for explanation purposes and should not be construed as a limitation on the use of the present invention.

While various aspects of the invention are described and illustrated herein as embodied in combination in the exemplary embodiments, these various aspects may be realized in many alternative embodiments, either individually or in various combinations and sub-combinations thereof. Unless expressly excluded herein all such combinations and sun-combinations are intended to be within the scope of the present invention. Still further, while various alternative embodiments as to the various aspects and features of the invention, such as alternative materials, structures, configurations, methods, devices, software, hardware, control logic and so on may be described herein, such descriptions are not intended to be a complete or exhaustive list of available alternative embodiments, whether presently known or later developed. Those skilled in the art may readily adopt one or more of the aspects, concepts or features of the invention into additional embodiments within the scope of the present invention even if such embodiments are not expressly disclosed herein. Additionally, even though some features, concepts or aspects of the invention may be described herein as being a preferred arrangement or method, such description is not intended to suggest that such feature is required or necessary unless expressly so stated. Still further, exemplary or representative values and ranges may be included to assist in understanding the present invention however, such values and ranges are not to be construed in a limiting sense and are intended to be critical values or ranges only if so expressly stated.

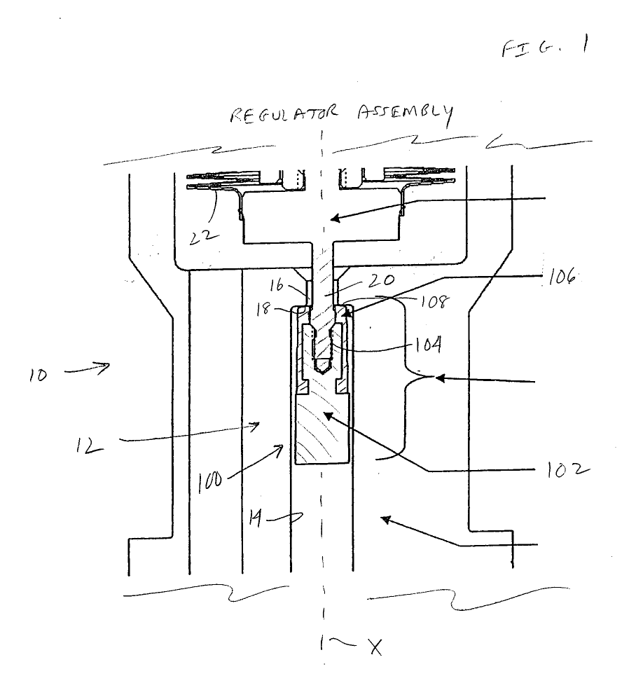

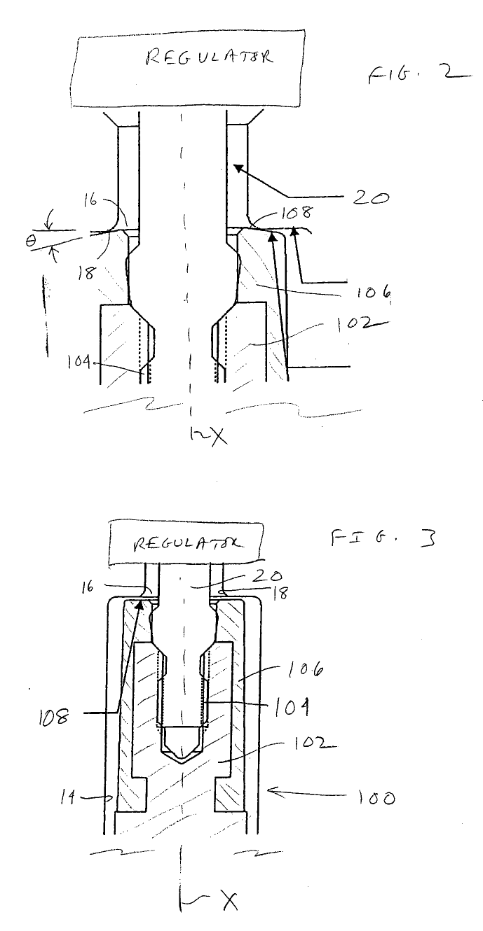

With reference to FIGS. 1 and 2 a pressure regulator 10 is illustrated in a closed position, such as a regulator as described in U.S. Pat. No. 5,303,734 the entire disclosure of which is fully incorporated herein by reference. The invention may be used in any of a wide variety of regulator designs or other flow control devices that use a poppet flow control mechanism. The present invention provides a new poppet design that may be used in place of the poppet of the above identified patent of other flow control devices. The regulator 10 otherwise operates in accordance with its design as is well known, and the overall function and design of the regulator forms no part of the present invention other than the poppet. Accordingly, only the poppet section of the regulator is illustrated herein.

The regulator 10 includes a body 12. The body 12 has a flow passage 14 formed therein that slideably receives a poppet assembly 100. The body 12 typically is made of metal, such as for example, stainless steel. An orifice 16 is formed by a valve seat 18 provided at one end of the flow passage 14. The seat 18 may have any suitable geometry such as a radius for example.

The poppet assembly 100 includes a core 102 such as made of metal or other suitably hard material. The core 102 may be made of stainless steel, for example. The core 102 includes a threaded bore 104 so that the poppet assembly 100 can be installed on a stem 20 that is operably coupled to the regulator, such as a bellows 22. A non-threaded connection between the stem 20 and the poppet assembly 100 may alternately be used.

The poppet assembly 100 further includes a softer upper casing 106. Preferably although not necessarily the casing 106 is an over-molded elastomeric material that is directly molded onto the core 102. Although it is not required that the casing 106 be over-molded, it is generally desirable as there is a more direct support of the casing 106 on the core 102. This helps maintain the geometric stability of the poppet. However, the invention is also advantageously useful with a casing 106 that is not over-molded.

Any suitable molding process may be used such as injection molding for example. The core 102 can be positioned in a mold cavity and the elastomer injected into the cavity so as to become intimately molded about the core 102.

A suitable material for the poppet casing 106 is a perfluoroelastomer such as, for example, FFKM, such as sold under the trade name KALREZ™. Other materials may be used such as FKM (such as VITON™), buna and ethylene propylene. The chosen material should exhibit chemical compatibility with the fluids flowing through the regulator, and have a sufficiently low enough durometer so as to form an excellent seal against the seat 18, yet hard enough and resilient enough to maintain its shape. By over-molding the elastomer onto the metal core a stable poppet geometry is produced.

In the embodiment of FIGS. 1 and 2, the top surface 108 of the poppet is slightly inclined at an angle θ relative to a line normal to the longitudinal axis X of the poppet. The slight incline may be in the range of about 5-15 degrees from this normal but other angles may be used as required. This poppet surface 108 forms a sealing surface that engages and seals onto the metal seat 18 on the regulator body.

In an alternative embodiment of FIG. 3, the poppet upper surface 108 is generally flat or normal to the axis X. All other aspects of the regulator and poppet may be the same as in the embodiment of FIGS. 1 and 2.

By molding a lower durometer elastomer onto the poppet core the advantage of a better seal between the poppet and body seat is realized. If allowed to set in this condition for a period of time the elastomer begins to deform and adopt the contour of the harder metal seat. At the instant the regulator is opened the poppet is moved into a position of controlling the outlet pressure in accordance with the forces common in regulators (i.e. fluid forces vs. the regulator spring forces) and a resulting outlet pressure and flow between the poppet and body is established. As the regulator remains in this force balanced state the deformed elastomer begins to relax and return to its original physical geometric state. While this return to original physical state does not affect the force balance it may affect the outlet pressure to a small degree (i.e. in the range of 1 to 2 psig fluctuation). By molding an angle into the top poppet surface it is believed that the stress distribution is focused more on the metal core 102, instead of the outer elastomer. This may reduce the volume of material that is compressed and therefore may reduce the amount the elastomer needs to recover, reducing the outlet pressure variation. The over-molded poppet concept (and alternatively the casing and poppet concept) when used provides for the use of a softer material such as an elastomer instead of rigid plastic. The elastomer provides for superior sealing performance by providing a softer material at the body orifice seal. For example, the material may have a Shore durometer reading of about 85.

The invention thus contemplates various aspects for an improved poppet design for flow control devices. The use of a softer material on a relatively harder core, such as for example an elastomer on a metal core, provides stability of the poppet geometry which produces a stable flow. Since an all plastic poppet is not used, the overall stability of the poppet is maintained while at the same time the softer elastomer can be used to form a good seal. The optional over-molded design also improves stability of the poppet geometry. The use of an angled poppet sealing surface better distributes the load when the valve is closed so as to reduce stress on the poppet, allowing the softer material to more readily return to its relaxed elastic state.

1. A poppet assembly comprising:
a poppet core and a layer of material over a portion of said core wherein said material is softer than said core.

2. The poppet of claim 1 wherein said core comprises metal and said material comprises an elastomer.

3. The poppet of claim 1 in combination with a pressure regulator wherein said layer of material forms a seal against a valve seat in said regulator.

4. The poppet of claim 2 wherein said material is over-molded on said core.

5. The poppet of claim 1 wherein said material comprises a perfluoroelastomer.

6. The poppet of claim 1 wherein said material forms a seal surface that is inclined at an angle relative to perpendicular of a longitudinal axis of the poppet.

7. In a pressure regulator of the type having a valve seat and a poppet that engages the valve seat and is moveable relative to the valve seat to regulate fluid pressure, the improvement comprising:
the poppet comprising a core and a casing that overlays a portion of said core, said core being metal and said casing being softer than said core.

8. The regulator of claim 7 wherein said casing comprises an elastomer.

9. The regulator of claim 7 wherein said casing comprises an over-molded elastomer.

10. The regulator of claim 7 wherein said casing comprises perfluoroelastomer.

11. The regulator of claim 10 wherein said core comprises stainless steel.

12. The regulator of claim 11 wherein said casing is over-molded on said core.

13. The regulator of claim 7 wherein said poppet has a longitudinal axis and said casing forms a seal surface that is inclined at an angle other than normal to said axis.

14. A method for forming a poppet assembly, comprising the steps of:
forming a core of a first hardness;
molding a layer of material over a portion of the core, said layer being softer than said core.

15. The method of claim 14 wherein said layer of material comprises an elastomer.

16. The method of claim 15 wherein said elastomer comprises a perfluoroelastomer.

17. The method of claim 14 comprising the step of forming a surface of said layer at an angle that is other than normal to a longitudinal axis of said core.

18. The method of claim 14 wherein said core comprises metal.

19. The method of claim 18 wherein said core comprises stainless steel.

20. The method of claim 15 wherein said core comprises stainless steel.
